(19) United States
(12) Patent Application Publication
(10) Pub. No.: US 2013/0127392 A1
(43) Pub. Date: May 23, 2013

(54) Systems and Methods for transformation and transportation of energy storage devices

(71) Applicant: Jason Rugolo, Scottsdale, AZ (US)

(72) Inventor: Jason Rugolo, Scottsdale, AZ (US)

(73) Assignee: earthCell, Inc., Oakland, CA (US)

(21) Appl. No.: 13/573,806

(22) Filed: Oct. 3, 2012

Related U.S. Application Data
(60) Provisional application No. 61/542,722, filed on Oct. 3, 2011.

(51) Int. Cl. H02J 7/00; B65D 27/06

(52) U.S. Cl. CPC H02J 7/0042; H02J 7/00; B65D 27/06; B65D 27/04
USPC 320/101; 320/107; 320/137; 229/300

(57) ABSTRACT

Disclosed herein are methods and system for managing distribution and transformation of energy storage devices. Also provided are computer-implemented methods for managing the distribution and transformation of energy storage devices. Also provided are mailers for distribution and transportation of energy storage devices; and charging units to transform energy storage devices from substantially uncharged to substantially charged state.

### CROSS-REFERENCE TO RELATED APPLICATION

The present application is a non-provisional application which claims priority to U.S. Provisional Patent Application No. 61/542,722, filed Oct. 3, 2011; all of which is herein incorporated by reference in its entirety.

### FIELD OF THE INVENTION

This invention relates to systems and methods for managing distribution, and transformation of energy storage devices. Charging units to transform energy storage devices from substantially uncharged to substantially charged state are provided herein. Also provided are mailers for distribution and transportation of energy storage devices.

### BACKGROUND OF THE INVENTION

Energy storage devices such as electrochemical cells store energy well and for a considerable length of time. Primary electrochemical cells are non-rechargeable, hence need to be discarded when the stored energy is depleted, and the cell is transformed from a charged state to an uncharged state. Certain rechargeable electrochemical cells maintain their capacity at high discharge rates, and can be periodically recharged to transform into a substantially charged state.

### SUMMARY OF THE INVENTION

Disclosed herein are methods and system for managing distribution and transformation of energy storage devices. Also provided are computer-implemented methods for managing the distribution and transformation of energy storage devices. Also provided are mailers for distribution and transportation of energy storage devices; and charging units to transform energy storage devices from substantially uncharged to substantially charged state.

Provided herein are systems for managing distribution and transformation of energy storage devices. In certain embodiments is a system for managing distribution and transformation of energy storage devices, wherein said system comprises: at least one mailer useful to receive substantially uncharged energy storage devices from a sender user, deliver substantially charged energy storage devices to a recipient user, or both; at least one charging unit for transforming said energy storage devices from a substantially uncharged state to a substantially charged state; at least one processing device; and at least one sequence of computer program instructions stored in an electronic digital memory in said processing device, which when executed cause at least one step selected from receipt, transformation, inventory, storage and initiation of delivery of energy storage devices. In certain embodiments, the processing device is a computer.

Provided are systems for managing distribution and transformation of energy storage devices, wherein transformation of the energy storage devices is performed by providing electricity in an amount sufficient to transform said energy storage devices from a substantially uncharged state to a substantially charged state. Certain embodiments of the systems described herein comprise at least one charging unit for transforming energy storage devices from a substantially uncharged state to a substantially charged state, wherein said charging unit can simultaneously charge a plurality of energy storage devices by transforming said devices from a substantially uncharged state to a substantially charged state. In some embodiments, the charging unit can simultaneously charge at least 10 energy storage devices. In an embodiment is a charging unit that can simultaneously charge at least 20 energy storage devices. In certain embodiments are charging units that can simultaneously charge at least 50 energy storage devices. In an embodiment provided is a charging unit that can simultaneously charge at least 100 energy storage devices. In some embodiments are charging units that can simultaneously charge at least 1000 energy storage devices.

Provided are systems for managing distribution and transformation of energy storage devices, wherein transformation of the energy storage devices is performed by providing electricity in an amount sufficient to transform said energy storage devices from a substantially uncharged state to a substantially charged state, and wherein the system regulates the supply of electricity to the energy storage devices. In an embodiment, the regulation further comprises prevention of overcharging charged energy storage devices. In some embodiments, the system regulates the supply of energy by performing hysteresis charging prior to constant voltage charging. In certain embodiments, the system regulates the supply of electricity so as to minimize charging during peak hours.

Provided are systems for managing distribution and transformation of energy storage devices, wherein transformation of the energy storage devices is performed by providing electricity in an amount sufficient to transform said energy storage devices from a substantially uncharged state to a substantially charged state, and wherein at least some of the electricity is obtained from a renewable source. In certain embodiments, the renewable source of electricity is solar. In certain embodiments, the renewable source of electricity is biomass, bio-fuel, geothermal, tidal, hydroelectric, wind, solar or combinations thereof.

Provided are systems for managing distribution and transformation of energy storage devices, wherein said energy storage devices are electrochemical cells. In certain embodiments, the electrochemical cell is a rechargeable electrochemical cell. In some embodiments, the electrochemical cell is a secondary electrochemical cell. In certain embodiments, the electrochemical cells have a power-to-weight ratio of about 50 to about 25000 W/kg. In some embodiments, the electrochemical cells are low self-discharge cells. In certain embodiments, the rechargeable electrochemical cells are alkaline cells. In certain embodiments, the rechargeable electrochemical cells are one or more of nickel-metal hydride cells, nickel-iron cells, nickel-cadmium cells, nickel-hydrogen cells, nickel-zinc cells, lithium ion cells, lithium polymer cells, lithium-iron-phosphate cells, lithium-sulfur cells, lithium-titanate cells, thin film lithium cells, zinc bromide cells, silver oxide cells, silver-zinc cells, vanadium redox cells, sodium-sulfur cells, molten salt cells and combinations thereof. In some embodiments, the rechargeable electrochemical cells are molten salt cells such as sodium-sulfur cells, lithium-sulfur cells, sodium-aluminum chloride cells or combinations thereof.

Provided herein is a system for managing distribution and transformation of energy storage devices, wherein said system comprises: at least one mailer useful to receive substantially uncharged energy storage devices from a sender user, deliver substantially charged energy storage devices to a recipient user, or both; at least one unit for transforming said substantially uncharged energy storage device into its component materials; at least one processing device; at least one sequence of computer program instructions stored in an electronic digital memory in said processing device, which when executed cause at least one step selected from receipt, transformation, inventory, storage and initiation of delivery of energy storage devices. In certain embodiments, the energy storage devices are electrochemical cells. In some embodiments, the electrochemical cell is non-rechargeable. In some embodiments, the electrochemical cell is a primary cell. In an embodiment, the electrochemical cell is a non-rechargeable alkaline cell. In an embodiment, the electrochemical cell is a non-rechargeable zinc-carbon cell, zinc-chloride cell, Oxy-nickel cell, lithium-copper oxide cell, lithium-iron disulfide cell, lithium-manganese dioxide cell, mercury oxide cell, silver oxide cell, silver-zinc cell, zinc-air cell or combinations thereof.

In certain embodiments of the systems described herein, the system comprises a mailer for transportation of energy storage devices, wherein said mailer comprises: a first panel comprising at least one receptacle, and at least one sealing element; a second panel comprising a sender address panel, and a receiver address panel, wherein said second panel is removably attached to said first panel by said at least one sealing element, wherein said at least one receptacle, second panel, and sealing element define a secure chamber to accept and securely transfer at least one energy storage device; and a postage panel positioned on said sender address panel.

Provided herein are methods of managing distribution and transformation of energy storage devices. In an embodiment is a computer-implemented method of managing distribution and transformation of energy storage devices, wherein said method comprises receiving substantially uncharged energy storage devices; transforming said energy storage devices from a substantially uncharged state to a substantially charged state; initiating delivery of charged energy storage devices to a user; utilizing at least one sequence of computer program instructions stored in an electronic digital memory in a computer to manage at least one step selected from receipt, transformation, inventory, storage and initiation of delivery of energy storage devices. In an embodiment is a method wherein transformation of the energy storage devices is performed by providing electricity in an amount sufficient to transform said energy storage devices from a substantially uncharged state to a substantially charged state. In certain embodiments the method further comprises regulating the supply of electricity to the energy storage devices. In some embodiments, the regulation further comprises prevention of overcharging charged energy storage devices.

Provided is a method of managing distribution and transformation of energy storage devices wherein said method comprises: receiving substantially uncharged energy storage devices; transforming said substantially uncharged energy storage devices into isolated component materials; initiating delivery of substantially charged energy storage devices to a user; utilizing at least one sequence of computer program instructions stored in an electronic digital memory in a computer to manage at least one step selected from receipt, transformation, inventory, storage and initiation of delivery of energy storage devices. In certain embodiments, at least one of delivery of energy storage device to the user or return of energy storage devices from the user is performed by means of a delivery service. In some embodiments, the delivery service is a mail delivery service. In certain embodiments, the delivery service is a courier service. In certain embodiments, the delivery service is an express mail service.

Provided herein is a mailer for conveying an energy storage device from a sender to a recipient and back, comprising: a first panel comprising at least one receptacle, and at least one sealing element; a second panel comprising a sender address panel, and a receiver address panel, wherein said second panel is removably attached to said first panel by said at least one sealing element, wherein said at least one receptacle, second panel, and sealing element define a secure chamber to accept and securely transfer at least one energy storage device; and a postage panel positioned on said sender address panel. In some embodiments, the receptacle holds a plurality of energy storage devices. In some embodiments the sender address panel and receiver address panel can be peeled away to reveal address and postage for returning the mailer to the sender.

In certain embodiments, the postage panel is aligned away from the secure chamber. In certain embodiments is a mailer wherein the sealing element aligns said secure chamber away from an impact region of a processing machine. In certain embodiments, the sealing element is an adhesive tape. In some embodiments, the sealing element is glue. In an embodiment, the sealing element is a Velcro tape. In an embodiment, the sealing element is a resealable zipper. In certain embodiments, the sealing element is a self-locking mechanism.

In certain embodiments of the mailer described herein, the secure chamber comprises an inner lining, said lining comprising an insulator material such that said material helps avoid the dissipation of charge in the energy storage device being transported. In some embodiments, the secure chamber comprises a protective inner lining that is shock-proof. In certain embodiments of the mailer described herein, the receptacle can be detached from the first panel. In an embodiment the receptacle can be connected to a source of energy such that an amount of energy is provided to transform from a substantially uncharged state to a substantially charged state, energy storage devices that are placed in the receptacle. In certain embodiments is a mailer described herein, wherein the first panel comprises a locking mechanism that activates when said at least one energy storage device is placed in the receptacle, and wherein said locking mechanism minimizes lateral displacement of the energy storage device during transportation. In certain embodiments of the mailer described herein, the first panel further comprises a release mechanism that is triggered by the recipient to release said at least one energy storage device from said receptacle.

Provided herein is a mailer for conveying an energy storage device from a sender to a recipient and back, comprising: a first panel comprising at least one receptacle, and at least one sealing element; a second panel comprising a sender address panel, and a receiver address panel, wherein said second panel is removably attached to said first panel by said at least one sealing element, wherein said at least one receptacle, second panel, and sealing element define a secure chamber to accept and securely transfer at least one energy storage device; and a postage panel positioned on said sender address panel, wherein said first panel comprises a mechanism to alert at least one of the sender and recipient. In certain embodiments, the alert mechanism is activated once all energy storage devices are removed from the receptacle. In some embodiments, the alert is activated when a plurality of energy storage devices are removed from the receptacle. In an embodiment the alert is activated when a majority of energy storage devices are removed from the receptacle. In certain embodiments, the alert is activated when at least half of the total number of energy storage devices originally present in the receptacle, are removed from the receptacle.

Provided is a mailer for conveying an energy storage device from a sender to a recipient and back, comprising: a first panel comprising at least one receptacle, and at least one sealing element; a second panel comprising a sender address panel, and a receiver address panel, wherein said second panel is removably attached to said first panel by means of said at least one sealing element, wherein said at least one receptacle, second panel, and sealing element define a secure chamber to accept and securely transfer a plurality of rechargable electrochemical cells; and a postage panel positioned on said sender address panel, wherein said postage panel is aligned away from said secure chamber. In certain embodiments, at least one of the first and second panels further comprises a code, wherein said code is scan-able. In certain embodiments, the code is machine readable. In certain embodiments is a mailer, further comprising a signaling tag. In some embodiments, the tag is activated when a plurality of energy storage devices are removed from the receptacle.

In certain embodiments of the mailer described herein, said mailer is substantially comprised of materials that are substantially recyclable. In certain embodiments, the mailer is between 50-100% recyclable. In an embodiment, the mailer is 90% recyclable. In certain embodiments, the mailer is substantially comprised of materials that are biodegradable. In some embodiments, the mailer is substantially comprised of materials that are recycled. In an embodiment, between 50-100% of the mailer is comprised of recycled material. In an embodiment, 75% of the mailer is comprised of recycled material.

Provided is a mailer as described herein, wherein said mailer further comprises a tracking panel attached to said first or second panel. In certain embodiments, the tracking panel comprises a tracking signal that can be processed by a processing device to estimate the location of the mailer. In certain embodiments the signal is a code that is scan-able. In some embodiments, the code is a barcode. In an embodiment, the barcode is a matrix barcode such as, but not restricted to datamatrix, and Quick Response (QR) code. In certain embodiments, the tracking signal is a radio-frequency signal.

Provided herein is a method of efficiently recycling energy storage devices comprising: receiving at least one energy storage device in a substantially uncharged state; transforming said energy storage device from a substantially uncharged state to a substantially charged state; initiating transportation of said at least one energy storage device to a user such that said user receives said device in substantially charged state; receiving back from user said at least one energy storage device in substantially uncharged state. In an embodiment is a method of efficiently recycling energy storage devices, wherein the energy storage device is an electrochemical cell. In certain embodiments, the electrochemical cell is rechargeable. In some embodiments, the energy storage devices are transported in a mailer, and the method further comprises the step of initiating transportation of at least one substantially charged energy storage device to recipient after issuance of an alert. In certain embodiments of the mailer described herein, the receptacle further comprises a section for transportation of non-rechargeable energy storage devices.

A system for managing distribution and transformation of energy storage devices, wherein said system comprises at least one mailer to: receive substantially uncharged energy storage devices from a sender user, deliver substantially charged energy storage devices to a recipient user, or both; at least one transformation unit for transformation of said energy storage devices, said transformation selected from: transformation of substantially uncharged energy storage devices to a substantially charged state by providing a sufficient amount of electricity, and transformation of energy storage devices into component materials; at least one processing device; and at least one sequence of computer program instructions stored in an electronic digital memory in said processing device, which when executed cause at least one step selected from receipt, transformation, inventory, storage and initiation of delivery of energy storage devices. In certain embodiments, the transformation unit can simultaneously charge a plurality of energy storage devices by transforming said devices from a substantially uncharged state to a substantially charged state.

Other aspects and features of the present invention will become apparent to those ordinarily skilled in the art upon review of the following description of specific embodiments of the invention.

### BRIEF DESCRIPTION OF THE FIGURES

FIG. 1 shows a flowchart depicting a method of managing distribution and transformation of energy storage devices

FIG. 2 shows an embodiment of a charging device used to transform energy storage devices 2 from a substantially uncharged state to a substantially charged state.

FIG. 3 shows an embodiment of a mailer 1 used to transport and store energy storage devices.

FIG. 4 shows a view of an embodiment of a mailer useful to transport and store energy storage devices.

FIG. 5 shows an embodiment of a sealed mailer used to transport and store energy storage devices.

FIG. 6 shows an embodiment of an open mailer used to transport and store energy storage devices.

FIG. 7 shows a receptacle 500 that is placed in a mailer used to transport and store energy storage devices.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

### DETAILED DESCRIPTION OF THE INVENTION

Provided herein are systems for managing distribution and transformation of energy storage devices. In certain embodiments is a system for managing distribution and transformation of energy storage devices, wherein said system comprises: at least one mailer for receiving substantially uncharged energy storage devices from a user and delivering substantially charged energy storage devices to said user; at least one charging unit for transforming said energy storage devices from a substantially uncharged state to a substantially charged state; at least one processing device; and at least one sequence of computer program instructions stored in an electronic digital memory in said processing device, which when executed cause at least one step selected from receipt, transformation, inventory, storage and initiation of delivery of energy storage devices. In certain embodiments, the processing device is a computer.

In general the following words and phrases have the indicated definitions when used in the description, examples and claims.

### Systems

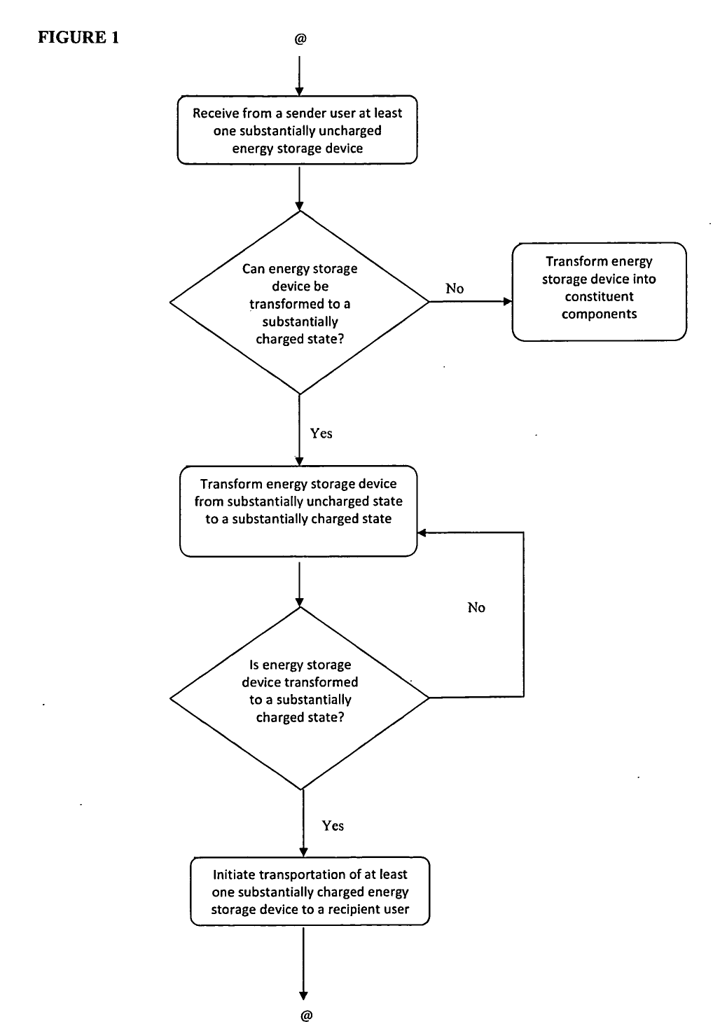

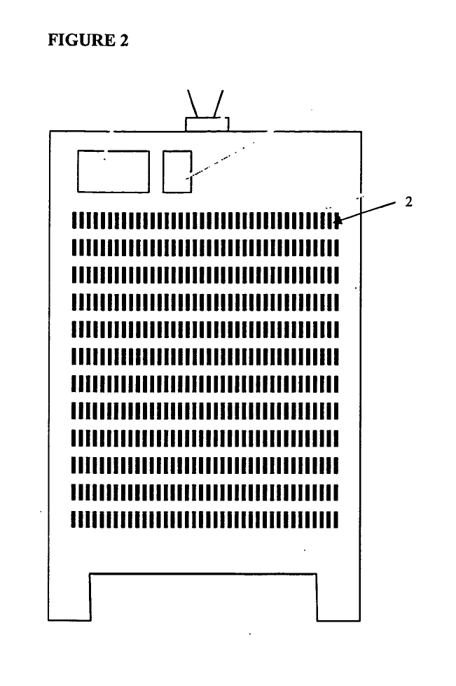

Provided are systems for managing distribution and transformation of energy storage devices (for instance as shown in FIG. 1), wherein transformation of the energy storage devices is performed by providing electricity in an amount sufficient to transform said energy storage devices from a substantially uncharged state to a substantially charged state. Certain embodiments of the systems described herein comprise at least one charging unit for transforming energy storage devices from a substantially uncharged state to a substantially charged state, wherein said charging unit can simultaneously charge a plurality of energy storage devices by transforming said devices from a substantially uncharged state to a substantially charged state (such as the unit in FIG. 2). In some embodiments, the charging unit can simultaneously charge at least 10 energy storage devices. In an embodiment is a charging unit that can simultaneously charge at least 20 energy storage devices. In certain embodiments are charging units that can simultaneously charge at least 50 energy storage devices. In an embodiment provided is a charging unit that can simultaneously charge at least 100 energy storage devices. In some embodiments are charging units that can simultaneously charge at least 1000 energy storage devices.

Provided are systems for managing distribution and transformation of energy storage devices, wherein transformation of the energy storage devices is performed by providing electricity in an amount sufficient to transform said energy storage devices from a substantially uncharged state to a substantially charged state, and wherein the system regulates the supply of electricity to the energy storage devices. In an embodiment, the regulation further comprises prevention of overcharging charged energy storage devices. In some embodiments, the system regulates the supply of energy by performing hysteresis charging prior to constant voltage charging. In certain embodiments, the system regulates the supply of electricity so as to minimize charging during peak hours.

Provided are systems for managing distribution and transformation of energy storage devices, wherein transformation of the energy storage devices is performed by providing electricity in an amount sufficient to transform said energy storage devices from a substantially uncharged state to a substantially charged state, and wherein at least some of the electricity is obtained from a renewable source. In certain embodiments, the renewable source of electricity is solar. In certain embodiments, the renewable source of electricity is biomass, bio-fuel, geothermal, tidal, hydroelectric, wind, solar or combinations thereof.

Provided are systems for managing distribution and transformation of energy storage devices, wherein said energy storage devices are electrochemical cells. In certain embodiments, the electrochemical cell is a rechargeable electrochemical cell. In some embodiments, the electrochemical cell is a secondary electrochemical cell. In certain embodiments, the electrochemical cells have a power-to-weight ratio of about 50 to about 25000 W/kg. In some embodiments, the electrochemical cells are low self-discharge cells. In certain embodiments, the rechargeable electrochemical cells are alkaline cells. In certain embodiments, the rechargeable electrochemical cells are one or more of nickel-metal hydride cells, nickel-iron cells, nickel-cadmium cells, nickel-hydrogen cells, nickel-zinc cells, lithium ion cells, lithium polymer cells, lithium-iron-phosphate cells, lithium-sulfur cells, lithium-titanate cells, thin film lithium cells, zinc bromide cells, silver oxide cells, silver-zinc cells, vanadium redox cells, sodium-sulfur cells, molten salt cells and combinations thereof. In some embodiments, the rechargeable electrochemical cells are molten salt cells such as sodium-sulfur cells, lithium-sulfur cells, sodium-aluminum chloride cells or combinations thereof.

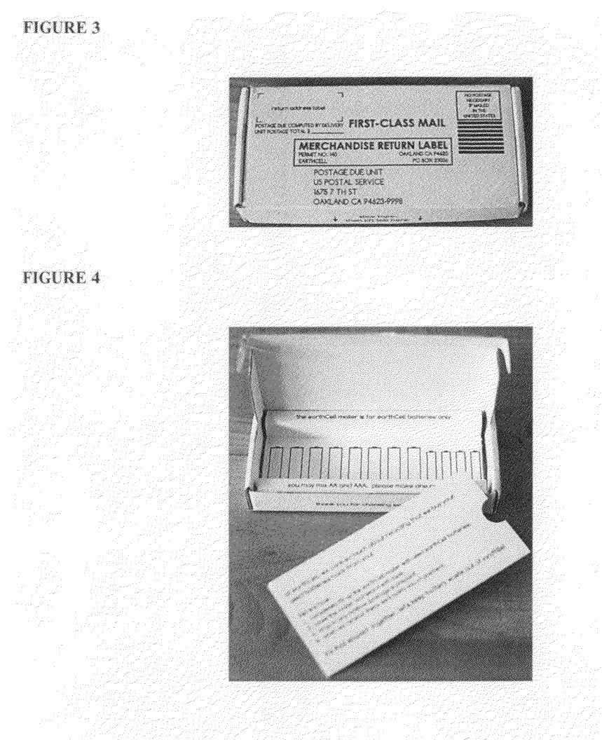

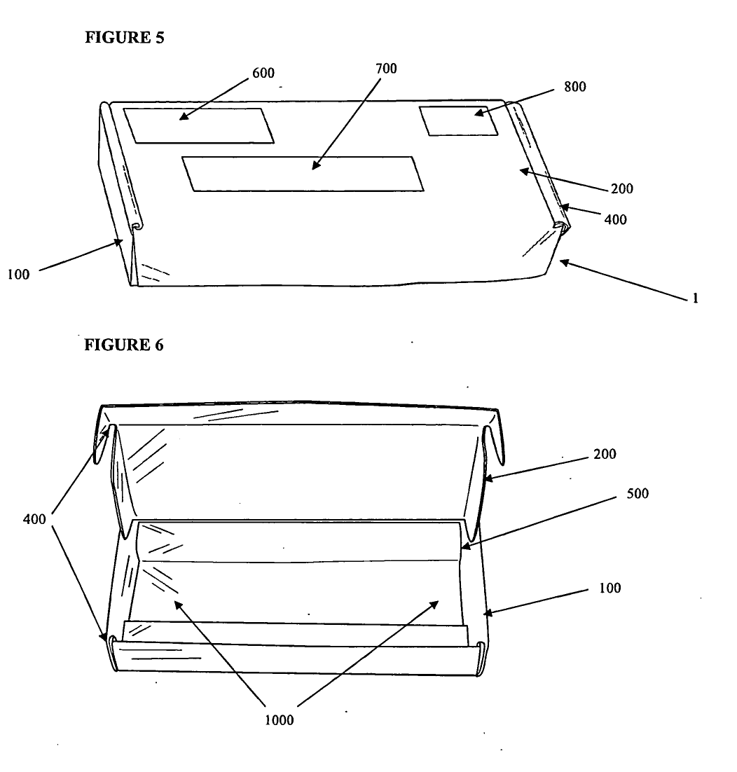

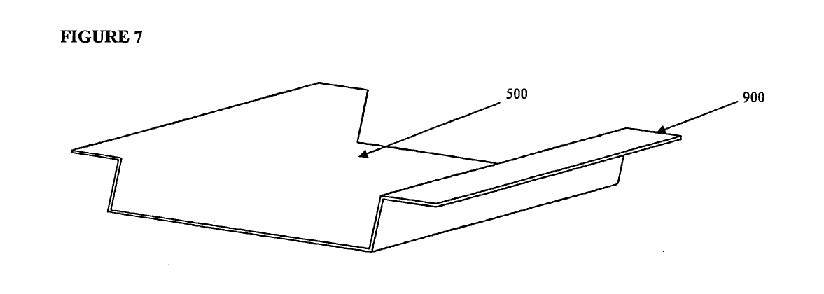

Provided herein is a system for managing distribution and transformation of energy storage devices, wherein said system comprises: at least one mailer (such as, but not restricted to the mailers illustrated in FIGS. 2-7) useful to receive substantially uncharged energy storage devices from a sender user, deliver substantially charged energy storage devices to a recipient user, or both; at least one unit for transforming said substantially uncharged energy storage device into its component materials; at least one processing device; at least one sequence of computer program instructions stored in an electronic digital memory in said processing device, which when executed cause at least one step selected from receipt, transformation, inventory, storage and initiation of delivery of energy storage devices. In certain embodiments, the energy storage devices are electrochemical cells. In some embodiments, the electrochemical cell is non-rechargeable. In some embodiments, the electrochemical cell is a primary cell. In an embodiment, the electrochemical cell is a non-rechargeable alkaline cell. In an embodiment, the electrochemical cell is a non-rechargeable zinc-carbon cell, zinc-chloride cell, Oxy-nickel cell, lithium-copper oxide cell, lithium-iron disulfide cell, lithium-manganese dioxide cell, mercury oxide cell, silver oxide cell, silver-zinc cell, zinc-air cell or combinations thereof.

In certain embodiments of the systems described herein, the system comprises a mailer for transportation of energy storage devices, wherein said mailer comprises: a first panel comprising at least one receptacle, and at least one sealing element; a second panel comprising a sender address panel, and a receiver address panel, wherein said second panel is removably attached to said first panel by said at least one sealing element, wherein said at least one receptacle, second panel, and sealing element define a secure chamber to accept and securely transfer at least one energy storage device; and a postage panel positioned on said sender address panel.

Provided herein are methods of managing distribution and transformation of energy storage devices. In an embodiment is a computer-implemented method of managing distribution and transformation of energy storage devices, wherein said method comprises receiving substantially uncharged energy storage devices; transforming said energy storage devices from a substantially uncharged state to a substantially charged state; initiating delivery of charged energy storage devices to a user; utilizing at least one sequence of computer program instructions stored in an electronic digital memory in a computer to manage at least one step selected from receipt, transformation, inventory, storage and initiation of delivery of energy storage devices. In an embodiment is a method wherein transformation of the energy storage devices is performed by providing electricity in an amount sufficient to transform said energy storage devices from a substantially uncharged state to a substantially charged state. In certain embodiments the method further comprises regulating the supply of electricity to the energy storage devices. In some embodiments, the regulation further comprises prevention of overcharging charged energy storage devices.

Provided is a method of managing distribution and transformation of energy storage devices wherein said method comprises: receiving substantially uncharged energy storage devices; transforming said substantially uncharged energy storage devices into component materials; initiating delivery of substantially charged energy storage devices to a user; utilizing at least one sequence of computer program instructions stored in an electronic digital memory in a computer to manage at least one step selected from receipt, transformation, inventory, storage and initiation of delivery of energy storage devices. In certain embodiments, at least one of delivery of energy storage device to a recipient user or return of energy storage devices from a sender user is performed by means of a delivery service. In some embodiments, the delivery service is a mail delivery service. In certain embodiments, the delivery service is a courier service. In certain embodiments, the delivery service is an express mail service.

### Energy Storage Device

“Energy storage device” means any device that is capable of storing or producing electrical energy. In certain embodiments, the energy storage device is an electrochemical cell that can convert stored chemical energy into electrical energy.

In some embodiments, the electrochemical cells are primary cells wherein the electrochemical reaction that converts stored chemical energy into electrical energy is irreversible. Hence, these cells once used, cannot be transformed from substantially uncharged state to substantially charged state (non-rechargeable cells). In an embodiment, the non-rechargeable cell is a non-rechargeable alkaline cell. In some embodiments, the non-rechargeable cell is a non-rechargeable zinc-carbon cell, zinc-chloride cell, Oxy-nickel cell, lithium-copper oxide cell, lithium-iron disulfide cell, lithium-manganese dioxide cell, mercury oxide cell, silver oxide cell, silver-zinc cell, zinc-air cell or combinations thereof.

In some embodiments, the electrochemical cell is a secondary cell, also referred to as a rechargeable cell or a storage cell. In these cells, the electrochemical reactions are electrically reversible. Hence, these cells can be transformed from a substantially uncharged state to a substantially charged state by means of a charging device. In certain embodiments, the rechargeable electrochemical cells are alkaline cells. In certain embodiments, the rechargeable electrochemical cells are one or more of nickel-metal hydride cells, nickel-iron cells, nickel-cadmium cells, nickel-hydrogen cells, nickel-zinc cells, lithium ion cells, lithium polymer cells, lithium-iron-phosphate cells, lithium-sulfur cells, lithium-titanate cells, thin film lithium cells, zinc bromide cells, silver oxide cells, silver-zinc cells, vanadium redox cells, sodium-sulfur cells, molten salt cells and combinations thereof. In some embodiments, the rechargeable electrochemical cells are molten salt cells such as sodium-sulfur cells, lithium-sulfur cells, sodium-aluminum chloride cells or combinations thereof.

In certain embodiments, the electrochemical cells have a power-to-weight ratio of about 50 to about 25000 W/kg. In some embodiments, the electrochemical cells are low self-discharge cells. In certain embodiments, the electrochemical cells have specific energy of 0.05-3.0 MJ/Kg. In an embodiment, the electrochemical cells have specific energy of 0.1-0.2 MJ/Kg. In certain embodiments, the electrochemical cells have specific energy of 0.1-0.5 MJ/Kg. In certain embodiments, the electrochemical cells have specific energy of 0.5-1.5 MJ/Kg. In some embodiments, the electrochemical cells provided herein have a nominal cell voltage of 0.5-10V. In an embodiment, the electrochemical cells provided herein have a nominal cell voltage of 1.2V. In an embodiment, the electrochemical cells provided herein have a nominal cell voltage of 1.5V. In an embodiment, the electrochemical cells provided herein have a nominal cell voltage of 1.7V. In an embodiment, the electrochemical cells provided herein have a nominal cell voltage of 3.6V. In certain embodiments, the electrochemical cells are of dimensions compliant with the recommendations of the International Electrochemical Commission or American National Standards Institute. In certain embodiments, the electrochemical cell is AAA cell. In some embodiments, the electrochemical cell is a AA cell. In some embodiments, the electrochemical cells are one or more of C cell, D cell, Lantern cell, PP3 cell, 1/2AA cell, AAAA cell, A cell, B cell, F cell, N cell, No. 6 cell, Sub-C cell, A23 cell, A27 cell, 4SR44 cell, 523 cell, 531 cell, J cell, PP1 cell, PP3 cell, PP6 cell, PP7 cell, PP8 cell, PP9 cell, PP10 cell, PP11 cell, CR123A cell, CR2 cell, 2CR5 cell, CR-P2 cell, CR-V3 cell, CR11108 cell, CR3032 cell, CR2477 cell, CR2450 cell, CR2430 cell, CR2354 cell, CR2330 cell, CR2032 cell, CR2025 cell, CR927 cell, CR1025 cell.

In certain embodiments described herein, “transformation of an energy storage device” comprises transforming said device from a substantially uncharged state to a substantially charged state or from a substantially charged state to a substantially uncharged state.

In some embodiments, a substantially charged state is one wherein the energy storage device is charged to about 50% of its capacity. In an embodiment, the substantially charged state is one wherein the energy storage device is charged to about 60% of its capacity. In some embodiments, a substantially charged state is one wherein the energy storage device is charged to about 65% of its capacity. In some embodiments, a substantially charged state is one wherein the energy storage device is charged to about 70% of its capacity. In some embodiments, a substantially charged state is one wherein the energy storage device is charged to about 75% of its capacity. In some embodiments, a substantially charged state is one wherein the energy storage device is charged to about 80% of its capacity. In some embodiments, a substantially charged state is one wherein the energy storage device is charged to about 85% of its capacity. In some embodiments, a substantially charged state is one wherein the energy storage device is charged to about 90% of its capacity. In some embodiments, a substantially charged state is one wherein the energy storage device is charged to about 95% of its capacity. In some embodiments, a substantially charged state is one wherein the energy storage device is charged to about 99% of its capacity. In some embodiments, a substantially charged state is one wherein the energy storage device is charged to about 100% of its capacity.

In some embodiments, a substantially uncharged state is one wherein the energy storage device has discharged more than about 50% of its energy storage capacity. In some embodiments, a substantially uncharged state is one wherein the energy storage device has discharged more than about 55% of its energy storage capacity. In some embodiments, a substantially uncharged state is one wherein the energy storage device has discharged more than about 60% of its energy storage capacity. In some embodiments, a substantially uncharged state is one wherein the energy storage device has discharged more than about 65% of its energy storage capacity. In some embodiments, a substantially uncharged state is one wherein the energy storage device has discharged more than about 70% of its energy storage capacity. In some embodiments, a substantially uncharged state is one wherein the energy storage device has discharged more than about 75% of its energy storage capacity. In some embodiments, a substantially uncharged state is one wherein the energy storage device has discharged more than about 80% of its energy storage capacity. In some embodiments, a substantially uncharged state is one wherein the energy storage device has discharged more than about 85% of its energy storage capacity. In some embodiments, a substantially uncharged state is one wherein the energy storage device has discharged more than about 90% of its energy storage capacity. In some embodiments, a substantially uncharged state is one wherein the energy storage device has discharged more than about 95% of its energy storage capacity. In some embodiments, a substantially uncharged state is one wherein the energy storage device has discharged about 100% of its energy storage capacity.

In certain embodiments described herein, “transformation of an energy storage device” comprises transforming said device into isolated component materials. To transform the energy storage devices into isolated component parts, the devices are first sorted based on the electrochemical cell type of each device. For instance, energy storage devices comprising cadmium are collected in a group; devices comprising lead are collected in a group etc. In certain embodiments, the transformation into isolated component materials is initiated by removing combustible material, such as but not restricted to plastics, paper and insulation, with an oxidizer. In certain embodiments, the oxidizer is a gas-fired thermal oxidizer. In certain embodiments, a scrubber is used to eliminate polluting particles created by the oxidation process, before releasing into the atmosphere. After this, the energy storage devices are heated until the metals that constitute said energy storage devices liquefy. In certain embodiments, the devices are chopped into small pieces prior to heating. In some embodiments, non-metallic substances are burned off; leaving a slag, and said slag is removed by a slag arm in certain embodiments. The metal alloys settle according to weight and are skimmed off while in liquid form.

For instance, cadmium is relatively light and vaporizes at high temperatures. For energy storage devices comprising cadmium, a fan blows the cadmium vapor into a cooled receptacle. In certain embodiments, the receptacle is the surface of a tube cooled internally with water mist. The vapors condense on the cool surface to produce cadmium. In some embodiments, the cadmium is of greater than 90% purity. In some embodiments, the cadmium is of greater than 95% purity. In some embodiments, the cadmium is of greater than 99% purity. In some embodiments, the cadmium is of greater than 99.5% purity.

In certain embodiments, the metals are not isolated any further than the alloy stage. In some embodiments, the metal alloys are transported to metal recovery plants where they are used to obtain isolated component metal such as but not limited to nickel, chromium and iron for stainless steel and other high-end products.

### Transformation Unit

A “transformation unit” is at least one device used for transformation of the energy storage devices, said transformation selected from: transformation of substantially uncharged energy storage devices to a substantially charged state by providing a sufficient amount of energy; and transformation of energy storage devices into component materials. In some embodiments, the transformation unit is a charging unit.

A “charging unit” is a device used to put energy into a rechargeable energy storage device such as a secondary electrochemical cell by forcing an electric current through it. The charge current depends upon the technology and capacity of the cell being charged.

In certain embodiments is provided a charging device that works by supplying a constant DC or pulsed DC power source to an energy storage device that is being charged. In some embodiments the charging device does not alter its output based on time or the extent of charge present in the energy storage device. In certain embodiments is provided an AC-powered charging device. In an embodiment, the AC-powered charging device has a ripple current that is under 5 amps.

In certain embodiments is provided a charging device that is a trickle charging device. Trickle charging means charging a rechargeable energy storage device at a similar rate as its self-discharging rate, thus maintaining the device at a substantially charged state. Some rechargeable electrochemical cells such as, but not restricted to nickel-cadmium cells or nickel metal hydride cells, have a moderate rate of self-discharge, meaning they gradually lose their charge even if they are not used in a device. In certain embodiments, the trickle charging device also comprises a regulator to ensure that the charge rate is not greater than the level of self-discharge in order to prevent overcharging and possible damage or leakage.

In certain embodiments is provided a charging device that is a float charging device which is a trickle charging device with circuitry to prevent overcharging. In certain embodiments, the float charging device senses when the energy storage device voltage is at the appropriate float level and temporarily ceases charging; it maintains the charge current at zero or a very minimal level until it senses that the output voltage from the energy storage device has fallen, and then resumes charging.

In certain embodiments, the charging device described herein further comprises a timer, which terminates the charging after a pre-determined time. In certain embodiments is provided a “smart charging device” for use with a “smart energy storage device.” In certain embodiments, a smart energy storage device is one comprising an electronic device or “chip” that can communicate with a smart charging device about the energy storage device characteristics and condition. A smart energy storage device generally requires a smart charging device it can communicate with. A smart charging device is defined as a charging device that can respond to the condition of an energy storage device, and modify its charging actions accordingly. Some smart charging are designed to transform smart energy storage devices from a substantially uncharged state to a substantially charged state. Some smart charging devices are designed to transform from a substantially uncharged state to a substantially charged state, any energy storage device that lacks internal electronic circuitry. The output current of a smart charging device depends upon the state of the energy storage device. Charging is terminated when a combination of the voltage, temperature and/or time indicates that the energy storage device is fully transformed to a charged state.

In certain embodiments, for Ni—Cd and NiMH electrochemical cells, the voltage across the cell increases slowly during the charging process, until the cell is fully transformed. After that, the voltage decreases, this in some embodiments indicates to a charging device that the electrochemical cell is fully transformed to a substantially charged state. Such charging devices are ΔV, “delta-V,” or sometimes “delta peak”, charging devices.

In certain embodiments, the charging device is a fast charging device. In some embodiments, the fast charging device makes use of control circuitry in the energy storage devices being charged to rapidly charge said storage devices without damage. In certain embodiments, the charging devices have a cooling fan to help keep the temperature of the cells under control.

In certain embodiments, the charging device uses pulse technology in which a series of voltage or current pulses is fed to the energy storage device. The DC pulses have a strictly controlled rise time, pulse width, pulse repetition rate (frequency) and amplitude. In certain embodiments, the charging devices use pulses to check the current cell state when first connected, and then use constant current charging during fast charging, then use pulse charging as a kind of trickle charging to maintain the charge. Some charging devices use “negative pulse charging”, also called “reflex charging” or “burp charging”. Such charging devices use both positive and brief negative current pulses. In certain embodiments, the charging unit used in a system described herein is a constant current charging unit.

In certain embodiments, the charging device is an inductive charging device that uses electromagnetic field to transfer energy to at least one energy storage device. The charging unit sends energy through inductive coupling to a receptacle which stores the energy in the energy storage devices. In certain embodiments, the receptacle is a removable receptacle places in a mailer to transport said energy storage devices.

In certain embodiments, the charging device is a solar charging device that converts light energy into electricity. In certain embodiments, solar charging devices are used for trickle charging. In certain embodiments, solar charging devices are used to completely transform the energy storage device from a substantially uncharged state to a substantially charged state. In certain embodiments, the charging device comprises turbines that convert kinetic energy into mechanical energy which is used to produce electricity. In certain embodiments, the turbines use kinetic energy from the wind. In some embodiments, the turbines use kinetic energy from sea-waves. In an embodiment, the electricity provided by the charging device to the energy storage device is obtained from a hydroelectric or wind source.

In some embodiments, the charging unit can simultaneously charge at least 10 energy storage devices. In an embodiment is a charging unit that can simultaneously charge at least 20 energy storage devices. In certain embodiments are charging units that can simultaneously charge at least 50 energy storage devices. In an embodiment provided is a charging unit that can simultaneously charge at least 100 energy storage devices. In some embodiments are charging units that can simultaneously charge at least 1000 energy storage devices. In some embodiments, are charging units that can simultaneously charge at least 10000 energy storage devices. In certain embodiments are charging units that can charge at least 100000 energy storage devices. In certain embodiments, a plurality of charging units are simultaneously provided in a system described herein. In a further embodiment, at least 5 charging units are simultaneously provided in a system described herein. In certain embodiments, 10 charging units are deployed simultaneously to charge a high plurality of energy storage devices. In an embodiment, 50 charging units are provided. In a further embodiment, at least 100 charging units are provided. In some embodiments, at least 1000 charging units that can simultaneously charge between 10 and 100000 energy storage devices are provided in systems described herein.

### Processing Device

The systems, programs, platforms, and methods described herein include a processing device, or use of the same. In certain embodiments described herein, the processing device is useful to manage distribution and transformation of energy storage devices. In certain embodiments, the processing device includes one or more hardware central processing units (CPU) that carry out the device's functions. In some embodiments, the processing device further comprises an operating system configured to perform executable instructions, a storage device, a display, an input device, a scanning device, and optionally a sound output device. In some embodiments, the digital processing device is optionally connected to the Internet such that it accesses the World Wide Web. In other embodiments, the processing device is optionally connected to an intranet. In other embodiments, the processing device is optionally connected to a data storage device.

In accordance with the description herein, suitable processing devices include, by way of non-limiting examples, server computers, desktop computers, laptop computers, notebook computers, sub-notebook computers, netbook computers, netpad computers, set-top computers, handheld computers, Internet appliances, mobile smart phones, tablet computers, personal digital assistants, and video game consoles. Those of skill in the art will recognize that many smart phones are suitable for use in the system described herein. Those of skill in the art will also recognize that select televisions and select digital music players with computer network connectivity are suitable for use in the system described herein. Suitable tablet computers include those with booklet, slate, and convertible configurations, known to those of skill in the art.

In some embodiments, the processing device described herein includes an operating system configured to perform executable instructions. The operating system is, for example, software, including programs and data, which manages the device's hardware and provides services for execution of applications, performed using the device. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In certain embodiments the processing device includes a storage and/or memory device. The storage and/or memory device is one or more physical apparatuses used to store data or programs on a temporary or permanent basis. In some embodiments, the memory device is volatile memory and requires power to maintain stored information. In some embodiments, the memory device is non-volatile memory and retains stored information when the digital processing device is not powered. In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In certain embodiments the processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, an OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In certain embodiments, the processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

In certain embodiments, a processing device described herein is useful to manage distribution of energy storage devices, said distribution comprising at least one of receiving substantially uncharged energy storage devices from a sender user; delivering substantially charged energy storage devices to a recipient user, or both. In certain embodiments, a processing device described herein is useful to manage transformation of substantially uncharged energy storage devices to substantially charged energy storage devices. In certain embodiments, a processing device described herein is useful to manage transformation of substantially uncharged energy storage device into its component materials. In certain embodiments, a processing device described herein is useful to manage to manage storage, and inventory of energy storage devices.

### Computer Network

The systems, programs, platforms, and methods disclosed herein include a processing device that is optionally connected to a computer network, or use of the same. A computer network is a collection of computers and/or devices interconnected by communications channels that facilitate communication and sharing resources among users, computers, or components of the network itself. In view of the disclosure provided herein, the computer network is created by techniques known to those of skill in the art using hardware, firmware, and software known to the art. In some embodiments, the computer network is a private network such as an intranet. In some embodiments, the computer network is the Internet. In further embodiments, the Internet provides access to the World Wide Web and the computer program is provided to the digital processing device via the Web. In still further embodiments, the Internet provides access to the World Wide Web and the computer program is provided to the digital processing device via cloud computing. In other embodiments, the computer network comprises data storage devices including, by way of non-limiting examples, CD-ROMs, DVDs, flash memory devices, magnetic disk drives, magnetic tapes drives, optical disk drives, and cloud computing based storage. In further embodiments, the computer program is provided to the digital processing device via a data storage device.

### Computer Program Instructions

The systems, programs, platforms, and methods described herein include instructions provided by means of a computer program, or use of the same. The computer program includes a sequence of instructions, executable in the processing device's CPU, written to perform a specified task. In light of the disclosure provided herein, those of skill in the art will recognize that the computer program, in various embodiments, utilizes one or more software frameworks and one or more database systems. In some embodiments, the computer program is created upon a software framework such as Microsoft® .NET or Ruby and Rails (RoR). In some embodiments, the computer program utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®.

Those of skill in the art will also recognize that the computer program, in various embodiments, is written in one or more versions of one or more languages. In certain embodiments, the computer program is written in an Object Oriented language. In certain embodiments, the computer program is written in one or more markup languages, presentation definition languages, client-side scripting languages, server-side coding languages, database query languages, or combinations thereof. In some embodiments, the computer program is written to some extent in a markup language such as Hypertext Markup Language (HTML), Extensible Hypertext Markup Language (XHTML), or eXtensible Markup Language (XML). In some embodiments, the computer program is written to some extent in a presentation definition language such as Cascading Style Sheets (CSS). In some embodiments, the computer program is written to some extent in a client-side scripting language such as Asynchronous Javascript and XML (AJAX), Flash® Actionscript, Javascript, or Silverlight®. In some embodiments, the computer program is written to some extent in a server-side coding language such as Active Server Pages (ASP), ColdFusion®, Perl, Java™, JavaServer Pages (JSP), Hypertext Preprocessor (PHP), Python™, Ruby, or Tcl. In some embodiments, the computer program is written to some extent in a database query language such as Structured Query Language (SQL). In some embodiments, the computer program is written to some extent in a programming language such as C, C++ or C#.

In certain embodiments, computer programming instructions are provided in electronic digital memory in a processing device described herein, said instructions useful to manage distribution of energy storage devices, said distribution comprising at least one of receiving substantially uncharged energy storage devices from a sender user; initiating delivery of substantially charged energy storage devices to a recipient user, or both. In certain embodiments, are provided computer program instructions to manage storage, and inventory of energy storage devices. In certain embodiments, computer programming instructions are provided in electronic digital memory in a processing device described herein, said instructions useful to manage transformation of substantially uncharged energy storage devices to substantially charged energy storage devices. In certain embodiments, computer programming instructions are provided in electronic digital memory in a processing device described herein, said instructions useful to manage transformation of substantially uncharged energy storage device into its component materials. In an embodiment is provided a sequence of computer program instructions as described herein, wherein said sequence of computer program instructions is stored in an electronic digital memory in a processing device, and wherein said sequence of computer program instructions when executed causes at least one of receipt, transformation, inventory, storage, and initiation of delivery of energy storage devices.

In certain embodiments, are provided computer program instructions for managing steps such as receipt, transformation, and initiation of delivery of energy storage device as described in FIG. 1. In some embodiments are provided computer program instructions for managing receipt of substantially uncharged energy storage devices from sender users, verifying if said energy storage devices can be transformed from said substantially uncharged state to a substantially charged state, managing transformation of said energy storage devices into substantially charged state or into constituent components (FIG. 1), verifying the transformation of the energy storage devices, and initiating transportation of substantially charged energy storage devices to recipient users.

### Modules

The systems, programs, platforms, and methods described herein include software, server, and database modules, or use of the same. In view of the disclosure provided herein, these modules are created by techniques known to those of skill in the art using machines, software, and languages known to the art. In some embodiments, the modules are in a single computer program. In other embodiments, the modules are in more than one computer program. In some embodiments, the modules are hosted on one machine. In other embodiments, the modules are hosted on more than one machine. In some embodiments, the modules are hosted on one or more machines in one location. In other embodiments, the modules are hosted on one or more machines in more than one location. Further described herein is the formatting of data. In some embodiments, the data files described herein are formatted in a data serialization format known to those in the art including, by way of non-limiting examples, tab-separated values, comma-separated values, character-separated values, delimiter-separated values, XML, JSON, BSON, and YAML.

### Mailer

Provided herein is a mailer 1 for conveying at least one energy storage device 2 from a sender to a recipient and back, comprising: a first panel 100 comprising at least one receptacle 500, and at least one sealing element 400; a second panel 200 comprising a sender address panel 600, and a receiver address panel 700, wherein said second panel is removably attached to said first panel 100 by said at least one sealing element 400, wherein said first panel 100, at least one receptacle 500, second panel 200, and sealing element 400 define a secure chamber 1000 to accept and securely transfer at least one energy storage device; and a postage panel 800 positioned on said second panel. In some embodiments, the receptacle holds a plurality of energy storage devices. In some embodiments the sender address panel and receiver address panel can be peeled away to reveal address and postage for returning the mailer to the sender.

In certain embodiments, the postage panel is aligned away from the secure chamber. In certain embodiments is a mailer 1 wherein the sealing element 400 aligns said secure chamber 1000 away from an impact region of a processing machine. In certain embodiments, the sealing element 400 is an adhesive tape. In some embodiments, the sealing element is glue. In an embodiment, the sealing element is a velcro tape. In an embodiment, the sealing element is a reseal-able zipper. In certain embodiments, the sealing element is a self-locking mechanism. In some embodiments, the sealing element is an interlocking mechanism activated by folding a crimped surface, or locking into place male and female members.

In certain embodiments of the mailer described herein, the secure chamber comprises an inner lining 900, said lining comprising an insulator material such that said material helps avoid the dissipation of charge in the energy storage device being transported. In some embodiments, the secure chamber comprises a protective inner lining that is shock-proof. In certain embodiments of the mailer described herein, the receptacle can be detached from the first panel. In an embodiment the receptacle can be connected to a source of energy such that an amount of energy is provided to transform from a substantially uncharged state to a substantially charged state, energy storage devices that are placed in the receptacle. In certain embodiments is a mailer described herein, wherein the first panel comprises a locking mechanism that activates when said at least one energy storage device is placed in the receptacle, and wherein said locking mechanism minimizes lateral displacement of the energy storage device during transportation. In certain embodiments of the mailer described herein, the first panel further comprises a release mechanism that is triggered by the recipient to release said at least one energy storage device from said receptacle.

Provided herein is a mailer 1 for conveying at least one energy storage device 2 from a sender to a recipient and back, comprising: a first panel 100 comprising at least one receptacle 500, and at least one sealing element 400; a second panel 200 comprising a sender address panel 600, and a receiver address panel 700, wherein said second panel is removably attached to said first panel by said at least one sealing element, wherein said first panel, at least one receptacle, second panel, and sealing element define a secure chamber 1000 to accept and securely transfer at least one energy storage device; and a postage panel positioned on said sender address panel, wherein said first panel comprises a mechanism to alert at least one of the sender and recipient. In certain embodiments, the alert mechanism is activated once all energy storage devices are removed from the receptacle. In some embodiments, the alert is activated when a plurality of energy storage devices are removed from the receptacle. In an embodiment the alert is activated when a majority of energy storage devices are removed from the receptacle. In certain embodiments, the alert is activated when at least half of the total number of energy storage devices originally present in the receptacle, are removed from the receptacle. In some embodiments, the alert instructs the user to request a new shipment of substantially charged energy storage devices. In certain embodiments the alert is a note placed inside the receptacle.

Provided is a mailer for conveying an energy storage device from a sender to a recipient and back, comprising: a first panel comprising at least one receptacle, and at least one sealing element; a second panel comprising a sender address panel, and a receiver address panel, wherein said second panel is removably attached to said first panel by means of said at least one sealing element, wherein said at least one receptacle, second panel, and sealing element define a secure chamber to accept and securely transfer a plurality of rechargeable electrochemical cells; and a postage panel positioned on said sender address panel, wherein said postage panel is aligned away from said secure chamber. In certain embodiments, at least one of the first and second panels further comprises a code, wherein said code is scan-able. In certain embodiments, the code is machine readable. In certain embodiments is a mailer, further comprising a signaling tag. In some embodiments, the tag is activated when a plurality of energy storage devices are removed from the receptacle.

In certain embodiments, a mailer described herein comprises a receptacle that is designed to hold a AA sized energy storage device without lateral displacement. In certain embodiments, a mailer described herein comprises a receptacle that is designed to hold a AAA sized energy storage device without lateral displacement. In certain embodiments of the mailer described herein, said mailer is substantially comprised of materials that are substantially recyclable. In certain embodiments, the mailer is between 50-100% recyclable. In an embodiment, the mailer is 90% recyclable. In certain embodiments, the mailer is substantially comprised of materials that are biodegradable. In some embodiments, the mailer is substantially comprised of materials that are recycled. In an embodiment, between 50-100% of the mailer is comprised of recycled material. In an embodiment, 75% of the mailer is comprised of recycled material.

Provided is a mailer as described herein, wherein said mailer further comprises a tracking panel attached to said first or second panel. In certain embodiments, the tracking panel comprises a tracking signal that can be processed by a processing device to estimate the location of the mailer. In certain embodiments the signal is a code that is scan-able. In some embodiments, the code is a barcode. In an embodiment, the barcode is a matrix barcode such as, but not restricted to datamatrix, and Quick Response (QR) code. In certain embodiments, the tracking signal is a radio-frequency signal.

Provided herein is a method of efficiently recycling energy storage devices comprising: receiving at least one energy storage device in a substantially uncharged state; transforming said energy storage device from a substantially uncharged state to a substantially charged state; initiating transportation of said at least one energy storage device to a user such that said user receives said device in substantially charged state; receiving back from user said at least one energy storage device in substantially uncharged state. In an embodiment is a method of efficiently recycling energy storage devices, wherein the energy storage device is an electrochemical cell. In certain embodiments, the electrochemical cell is rechargeable. In some embodiments, the energy storage devices are transported in a mailer, and the method further comprises the step of initiating transportation of at least one substantially charged energy storage device to recipient after issuance of an alert. In certain embodiments of the mailer described herein, the receptacle further comprises a section for non-rechargeable energy storage devices.

1. A system for managing distribution and transformation of energy storage devices, wherein said system comprises:
at least one mailer to: receive substantially uncharged energy storage devices from a sender user, deliver substantially charged energy storage devices to a recipient user, or both;
at least one transformation unit for transformation of said energy storage devices, said transformation selected from:
transformation of substantially uncharged energy storage devices to a substantially charged state by providing a sufficient amount of electricity; and
transformation of energy storage devices into component materials;
at least one processing device;
at least one sequence of computer program instructions stored in an electronic digital memory in said processing device, which when executed cause at least one step selected from receipt, transformation, inventory, storage and initiation of delivery of energy storage devices.

2. A system as described in claim 1, wherein said processing device is a computer.

3. (canceled)

4. A system as described in claim 1, wherein the transformation unit can simultaneously charge a plurality of energy storage devices by transforming said devices from a substantially uncharged state to a substantially charged state.

5. A system as described in claim 4, wherein the charging unit can simultaneously charge from about 10 to about 1000 energy storage devices.

6. (canceled)

7. (canceled)

8. (canceled)

9. (canceled)

10. A system as described in claim 1, wherein said system comprises a mechanism for the regulation of electricity to the energy storage devices, said regulation comprising at least one of: preventing overcharging of charged energy storage devices, and minimizing charging during peak hours.

11. (canceled)

12. A system as described in claim 1 wherein at least some of the electricity is obtained from a renewable source selected from solar, biomass, biofuel, geothermal, tidal, hydroelectric, wind and combinations thereof.

13. (canceled)

14. (canceled)

15. (canceled)

16. A system as described in claim 1 wherein each energy storage device is an electrochemical cell selected from a rechargeable cell and a non-rechargeable cell.

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. A mailer for conveying an energy storage device from a sender to a recipient and back, comprising:
a first panel comprising at least one receptacle, and at least one sealing element;
a second panel comprising a sender address panel, and a receiver address panel, wherein said second panel is removably attached to said first panel by said at least one sealing element, wherein said first panel, at least one receptacle which is optionally detachable, second panel, and sealing element define a secure chamber to accept and securely transfer at least one energy storage device; and
a postage panel positioned on said second panel.

32. A mailer as described in claim 31, wherein said sealing element aligns said secure chamber away from an impact region of a processing machine.

33. (canceled)

34. A mailer as described in claim 31, wherein said secure chamber comprises an inner lining, said lining comprising an insulator material such that said material minimizes the dissipation of charge in the energy storage device being transported as compared to a secure chamber not comprising an inner lining.

35. A mailer as described in claim 31 wherein said secure chamber comprises a protective inner lining that is shock-proof.

36. A mailer as described in claim 31 wherein said at least one energy storage device is an electrochemical cell which is selected from rechargeable electrochemical cell and non-rechargeable electrochemical cell, and wherein said electrochemical cell is optionally AA sized or AAA sized.

37. (canceled)

38. (canceled)

39. (canceled)

40. A mailer as described in claim 31 wherein the first panel optionally comprises a locking mechanism that activates when said at least one energy storage device is placed in the receptacle and minimizes lateral displacement of the energy storage device during transportation; and wherein said first panel optionally comprises a release mechanism that is triggered by the recipient to release said at least one energy storage device from said receptacle.

41. (canceled)

42. (canceled)

43. A mailer of claim 31 wherein said receptacle holds a plurality of energy storage devices.

44. A mailer as described in claim 31 wherein said first panel comprises an alert-mechanism to alert at least one of the sender and recipient, and wherein said alert-mechanism is activated upon the removal of a pre-determined number of energy storage devices from the receptacle.

45. (canceled)

46. (canceled)

47. (canceled)

48. A mailer as described in claim 31, wherein the sender address panel and receiver address panel can be peeled away to reveal address and postage for returning the mailer to the sender.

49. (canceled)

50. (canceled)

51. (canceled)

52. A mailer as described in claim 31 wherein at least one of said first and second panel further comprise a code, wherein said code is optionally at least one of a scan-able code and a machine readable code.

53. (canceled)

54. A mailer as described in claim 31, further comprising a signaling tag that is optionally activated when a predetermined number of energy storage devices are removed from the receptacle.

55. (canceled)

56. A mailer as described in claim 31, wherein said mailer comprising of materials that are recycled, substantially recyclable, substantially biodegradable or combinations thereof.

57. (canceled)

58. (canceled)

59. (canceled)

60. (canceled)

61. (canceled)

62. (canceled)

63. A mailer as described in claim 31 wherein said mailer further comprises a tracking panel attached to at least one of said first panel and said second panel said tracking panel optionally comprising a tracking signal that can be processed by a processing device to estimate the location of the mailer.

64. (canceled)

65. The mailer as described in claim 63, wherein said signal optionally comprises radio-frequency signal or a scan-able code, wherein said code is optionally a barcode which is optionally matrix barcode or a quick response code.

66. (canceled)

67. (canceled)

68. (canceled)

69. (canceled)

70. (canceled)

71. (canceled)

72. (canceled)

73. (canceled)

74. A method of efficiently recycling energy storage devices comprising:
receiving at least one energy storage device in a substantially uncharged state;
transforming said energy storage device from a substantially uncharged state to a substantially charged state;
initiating transportation of said at least one energy storage device to a user such that said user receives said device in substantially charged state;
receiving back from user said at least one energy storage device in substantially uncharged state.

75. The method of claim 74, wherein said energy storage device is a rechargeable electrochemical cell.

76. (canceled)

77. The method of claim 75, wherein said energy storage devices are transported in a mailer, and wherein the method comprises the step of initiating transportation of at least one substantially charged energy storage device to recipient after issuance of an alert.

78. (canceled)
